(19) United States
(12) Patent Application Publication
(10) Pub. No.: US 2011/0239376 A1
(43) Pub. Date: Oct. 6, 2011

(54) MULTI FUNCTION TOOL

(76) Inventor: Ronald W. Schmidt, Forest Lake, MN (US)

(21) Appl. No.: 13/080,283

(22) Filed: Apr. 5, 2011

Related U.S. Application Data
(60) Provisional application No. 61/338,596, filed on Apr. 5, 2010.

(51) Int. Cl. A45F 4/00; B25F 1/02; F23H 13/00

(52) U.S. Cl. 7/167; 7/115; 7/116; 7/148; 126/152 B

(57) ABSTRACT

A multi-purpose tool that is compact, easily stored, and readily transported and can provide a substantial number of the tools needed on a typical camping trip or outdoor activity. A multi-purpose tool comprises an outer elongated nesting member, an intermediate elongated nesting member, and an inner elongated nesting member. In various configurations, the inner nestable member and the intermediate nestable member may extend from either end of the outer nestable member to form any number of elongated tools. In another configuration of the embodiment, the inner nestable member and the intermediate nestable member may be retracted to the end of the outer nestable member to form more compact tools. A number of application-specific heads may be operably coupled to the nestable members to form camping tools. In another configuration, the nestable members may be unnested and operably coupled as individual members to form tripod or non-linear-shaped tools. The multi-purpose tool may include one or more optional mounts for operably coupling to various tool attachments. The multi-purpose tool may include a strap operably couplable to the plurality of nestable members.

### PRIORITY CLAIM

The present application claims the benefit under 35 U.S.C. §119(e) of U.S. Provisional Patent Application Ser. No. 61/338,596 filed on Apr. 5, 2010, which is hereby incorporated by reference in its entirety.

### FIELD OF THE INVENTION

The present invention relates to combination tools. More particularly, it relates to multi-purpose collapsible combination tools useful in camping and outdoor activities.

### BACKGROUND OF THE INVENTION

Typically, a camping trip requires tedious planning and preparation. Much of this planning revolves around which tools and equipment to bring, as all of the amenities of home will likely not be available at the camp site. Generally, this means making checklists of and subsequently bringing various pieces of single-use equipment, like a grill, a bear bag, a measuring device, a shovel, canoe paddles, camping chairs, a fishing rod holder, a fishing net, a fish cradle, a minnow net, a light pole, a deer drag, a bow or rifle holder, a shower bag hanger, a saw, a spear, a bow rack, a hiking stick, a tent assembly, and a camera stand, for example. Often, the sheer number of tools required for a successful camping trip is staggering.

Not only is the keeping track of the number of tools and equipment required burdensome, but these tools rarely fit together or pack in any sort of seamless or efficient way. As a result, the collection of camping equipment required for a typical camping trip is bulky and takes up a lot of space. Moreover, campers often must drive, with all their gear, to a location near the camp site. For campers without access to large vehicles or trailers, it can be onerous to try and pack all of the necessary equipment into a smaller or midsize vehicle.

Further, camping often involves hiking, walking, canoeing or otherwise manually traveling to a camp site, and/or moving from one camp site to another camp site. On the whole, the bulk of the aforementioned equipment is not easily transportable. Campers can often only make a single trip to a particular site, carrying only what can be strapped to their backs and secured in their hands. Therefore, it is difficult to travel with all of the necessary camping equipment.

Thus, there is a need for a multi-purpose camping tool that is efficiently stored and transported which can provide a majority of the camping equipment functionality required on a typical camping trip.

### SUMMARY OF THE INVENTION

The device of the present invention substantially meets the aforementioned needs of the industry. The multi-purpose tool provides a compact, easily stored and readily transported means for providing a substantial number of the tools needed on a typical camping trip or outdoor activity.

According to an embodiment of the invention, a multi-purpose tool generally includes a plurality of nestable members of substantially the same length, each having opposite apertured faces and a locking pin aligned through the series of apertured faces or a squared gland with a locking pin aligned through the series of apertured faces for securing the members. In one embodiment, a multi-purpose tool comprises an outer elongated nesting member, an intermediate elongated nesting member, and an inner elongated nesting member. In various configurations, the inner nestable member and the intermediate nestable member may extend from either end of the outer nestable member to form any number of elongated tools. In another configuration of the embodiment, the inner nestable member and the intermediate nestable member may be retracted to the end of the outer nestable member to form more compact tools. In another configuration of the embodiment, the nestable members may be unnested and operably coupled as individual members to form tripod or non-linear-shaped tools.

According to the embodiment, the multi-purpose tool may include a strap operably couplable to the plurality of nestable members. The strap may be used for carrying or transporting the multi-purpose tool, or for actual implementation as part of a piece of equipment. Further, according to the embodiment, the multi-purpose tool may include one or more optional mounts for operably coupling to various tool attachments or application-specific heads. For example, an accessory support member may comprise L-shaped projections operably coupleable to the plurality of nestable members. The projected ends may be used to operably couple various tool attachments or application-specific heads. In another example, according to the embodiment, the accessory support member may comprise squared glands or a mount comprising orthogonally disposed projections that extend orthogonally from the nestable members. Further, an accessory bag with straps for carrying can house the majority of accessories and tool attachments. Also, the multi-purpose tool may be sold as a kit with other camping-related supplies, including, but not limited to matches or a fire starting device, salt and pepper, a scotch pad, a hot dog roaster, and a grill grate.

According to another embodiment of the invention, a plurality of multi-purpose tools may be operably coupled together to form still a different tool.

According to embodiments of the invention, the fully nested, non-extended members can be a number of different lengths. For example, multi-purpose tools comprising members with lengths of 6″, 12″, 18″, 24″, and 30″ are considered. Such lengths are generally adaptable to form a majority of camping tools.

A feature and advantage of embodiments of the invention is the ability to form a camping chair. Three nestable members are unnested and instead, operably coupled intermediate the length of each member to form a secured tripod shape. The nestable members extend up to be operably coupled to a seat base at the distal end of each member, thus forming a traditional tripod camping chair.

A feature and advantage of embodiments of the invention is the ability to form a shovel of adjustable length. The nestable members are nested and secured with one or more locking pins or squared glands. The inner member and intermediate member are locked in a position such that they are extended outward past one end of the outer nestable member to form an elongated shovel handle. Alternatively, the inner member and intermediate member do not extend past the edge of the outer nestable member to form a more compact shovel handle. At the opposite end of the extended members, a shovel head is operably coupled to the nested members using a fastening mechanism, like a locking pin aligned through the apertured faces of the members, thus forming a shovel useful for camping activities.

A feature and advantage of embodiments of the invention is the ability to form a hand net for fishing. The nestable members are nested and secured with one or more locking pins or squared glands. The inner member and intermediate member are locked in a position such that they are extended outward past one end of the outer nestable member to form an elongated handle to form more of a dip net style of hand net. Alternatively, the inner member and intermediate member do not extend past the edge of the outer nestable member to form a more compact, traditional hand net handle. At the opposite end of the extended members, a netting head is operably coupled to the nested members using a fastening mechanism, like a locking pin aligned through the apertured faces of the members, thereby forming a fishing net and enabling the camping fisherman to net a fish.

A feature and advantage of embodiments of the invention is the ability to form a minnow seine or fish cradle. In such an embodiment, two sets of nestable members are nested and secured, respectively, with one or more locking pins or squared glands. The two sets of members are secured such that each forms the same length and are therefore able to act as the seine poles. A length of minnow seine netting is operably coupled between the two sets of members along the length of each set of members to form a fully functional minnow seine. Similarly, a length of cradle net is operably coupled between the two sets of members along the length of each set of members to form a fish cradle.

A feature and advantage of embodiments of the invention is the ability to form a spear of adjustable length. The nestable members are nested and secured with one or more locking pins or squared glands. The inner member and intermediate member are locked in a position such that they are extended outward past one end of the outer nestable member to form an elongated handle to form a longer spear. Alternatively, the inner member and intermediate member do not extend past the edge of the outer nestable member to form a shorter spear. At the opposite end of the extended members, a spear head is operably coupled to the nested members using a fastening mechanism, like a locking pin aligned through the apertured faces of the members. In an embodiment of the present invention, a single-pointed spear useful in frog hunting is utilized. In another embodiment of the present invention, a multi-pointed spear useful in fishing is utilized. Similarly, a multi-pointed fork can be operably coupled to the nested members using a fastening mechanism to form a pitchfork.

A feature and advantage of embodiments of the invention is the ability to form a camera stand of adjustable height. The nestable members are nested and secured with one or more locking pins or squared glands. The inner member and intermediate member are locked in a position such that they are extended outward past one end of the outer nestable member and the set of members forms a height appropriate for the particular desired camera application. For example, a shorter height would require an embodiment of completely nested shorter members, whereas a taller height would require an embodiment of extended and taller members. At the opposite end of the extended members, a camera mount and camera is operably coupled to the nested members using a fastening mechanism, thereby creating a stabilizing camera stand.

A feature and advantage of embodiments of the invention is the ability to form a canoe paddle of adjustable length. The nestable members are nested and secured with one or more locking pins or squared glands. The inner member and intermediate member are locked in a position such that they are extended outward past one end of the outer nestable member to form an elongated canoe paddle handle. Alternatively, the inner member and intermediate member do not extend past the edge of the outer nestable member to form a shorter paddle. At the opposite end of the extended members, a paddle head is operably coupled to the nested members using a fastening mechanism, like a locking pin aligned through the apertured faces of the members, thereby forming a canoe paddle.

A feature and advantage of embodiments of the invention is the ability to form a fishing rod holder or extender. The nestable members are nested and secured with one or more locking pins or squared glands. The inner member and intermediate member are locked in a position such that they are extended outward past one end of the outer nestable member to form an elongated fishing rod holder. The smaller-width inner nesting member and intermediate nesting member are easily insertable into soft ground, like the sand of a beach. At the opposite end of the extended members, a fishing rod is operably coupled to the nested members using a fastening mechanism, such as by threading the rod through one or more of the clevis fasteners of the locking pins.

A feature and advantage of embodiments of the invention is the ability to form a saw of adjustable length. The nestable members are nested and secured with one or more locking pins or squared glands. The inner member and intermediate member are locked in a position such that they are extended outward past one end of the outer nestable member. The plurality of members thus forms an elongated saw handle. Alternatively, the inner member and intermediate member are not extended as far past the outer nestable member to form a saw handle of shorter length. At any length, the inner member extends such that it can be coupled to two sets of L-shaped projected ends. A saw blade can be coupled to the distal-most orthogonally projected end of each L-shaped projected end, thus creating a saw with a traditional saw shape having void between the frame and the blade.

A feature and advantage of embodiments of the invention is the ability to form an adjustable bow, rifle, or lantern holder. In one embodiment, a bow, rifle, or lantern holder may be coupled to a tree or post. The outer member is unnested but coupled at one end at an angle to an end of the remaining members, which remain nested and are secured themselves using one or more locking pins or squared glands. The outer member and the still-nested members are coupled using an accessory support member that extends from within the volume of the outer member to form the angle. The strap is operably coupled to the nested members and wrapped around a tree or post such that the length of the nested members runs with the trunk of the tree or length of post. Because of the angled accessory support member forming a rigid angle, the outer member then projects orthogonally from the tree and can be utilized to hang bows, rifles, or lanterns. In another embodiment, a bow, rifle, or lantern holder may be inserted into the ground. In such an embodiment, the outer member is unnested but coupled intermediate its length to an end of the remaining members, which remain nested and are secured themselves using one or more locking pins or squared glands. The outer member and the nested members are coupled using an angular bracket, whereby the outer member is positioned relatively perpendicular to the ground. The T-shaped embodiment can be inserted into the ground tree and then utilized to hang bows, rifles, or lanterns.

A feature and advantage of embodiments of the invention is the ability to form a deer drag. The nestable members are nested and secured with one or more locking pins or squared glands to form a handle. The strap is coupled intermediate the length of the nestable members and coupled at the other end to a deer, thus forming a deer drag for transporting deer or other large animals. Alternatively, only one of the nested members need be used as the handle for the deer drag.

A feature and advantage of embodiments of the invention is the ability to measure fish. Often, certain size catch limits limit the size of fish that can be removed from a lake. A measuring device is printed on the face of one of the outer-facing nested members so as to provide a readily-usable measuring stick to gauge the fish.

A feature and advantage of embodiments of the invention is the ability to form a walking stick, crutch, cane, or ski pole or other assisting device of adjustable length. The nestable members are nested and secured with one or more locking pins or squared glands. The inner member and intermediate member are locked in a position such that they are extended outward past one end of the outer nestable member to form a linear structure of appropriate length for the user and the activity. For example, to create a walking stick for a user measuring 6′4″ in height, the inner member and intermediate member should be extended further from the end of the outer nestable member than the extension of the inner member and intermediate member for the user measuring 5″6″ in height. Further, one of the members may be unnested and attached perpendicularly with an angled bracket at the point where a user's armpit would rest to create a crutch. Thus, walking sticks, crutches, canes, ski poles or other assisting devices of adjustable length can be formed.

A feature and advantage of embodiments of the invention is the ability to form a light pole of adjustable length. In such a form, the nestable members are nested but extended to the full length and secured with one or more locking pins or squared glands. At the opposite end of the extended members, a flood light or light fixture is operably coupled to the outer member using a fastening mechanism, like a locking pin aligned through the apertured faces of the member. The entire extension can be secured with straps to a sturdy base, like a small tree or utility box, thus forming a light stand. Alternatively, one or more of the sets of members can be coupled together to extend the light further into the air.

A feature and advantage of embodiments of the invention is the ability to form a shower bag hanger of adjustable length. The nestable members are nested and secured with one or more locking pins or squared glands. The inner member and intermediate member are locked in a position such that they are extended outward past one end of the outer nestable member. At the opposite end of the extended members, a shower bag is operably coupled to the nested members using a fastening mechanism, like a carabiner or other hooking mechanism. The entire assembly can be strapped to a tree or pole using the strap couplable to the nestable members, thus forming a shower bag hanger useful for showering outdoors.

A feature and advantage of embodiments of the invention is the ability to form a lean-to or shelter stake of adjustable length. In such an embodiment, a tarp or waterproof covering is stretched and secured between trees or posts. The nestable members are nested and secured with one or more locking pins or squared glands. The inner member and intermediate member are locked in a position such that they are extended outward past one end of the outer nestable member at such a length that the members extend from the ground to the tarp or covering and create a pointed top, thus creating a shelter that sheds rain.

A feature and advantage of embodiments of the invention is the ability to form a Y-shaped rifle rest. In such an embodiment, the nestable members are unnested. The inner member is positioned perpendicular to and touching the ground, with each of the other two members operably coupled at their ends to the distal end of the inner member such that an obtuse angle is formed with the inner member. A Y-shaped rifle rest is thereby formed.

A feature and advantage of embodiments of the invention is the ability to form a grill and grill stand. In such an embodiment, the nestable members are unnested and positioned substantially perpendicular to the ground, but angled slightly inward to form an acute angle with the surface of the ground, and equidistant each other in a circle over a campfire. The members are operably coupled together at the distal end of each member, for example, with a ring positioned through one of the apertures in each member, thereby forming the grill-mountable sides of a conical grill stand. A traditional circular grill grate can be coupled parallel to the ground and intermediate the length of each member such that it is positioned at any of the apertured locations an appropriate distance from the fire for cooking.

Alternatively, a foldable grill plate can be utilized, thus saving on packing and carrying space. In one embodiment, a foldable grill grate comprises four foldable, hinged sections—a first outer section, a second outer section, a first inner section, and a second inner section. When completely unfolded, the foldable grill grate has a threaded cooking surface just like a traditional grill grate. However, it is segmented such that it is collapsible into roughly one-third of the original diameter. To collapse the grill, the outer sections fold inward towards the center such that the first outer section rotates about the axis shared by the first outer section and the first inner section, and the second outer section section rotates about the axis shared by the second outer section and second inner section The first inner section and second inner section (with first outer section and second outer section positioned vertically above each, respectively) can fold towards the center by rotating about the axis shared by the first inner section and the second inner section. Therefore, a space-saving foldable grill grate is contemplated.

Additionally, a number of traditionally non-camping tools can be formed. A feature and advantage of embodiments of the invention is the ability to form a pool cue of adjustable length. Much like many of the above-described tools of adjustable length, the nestable members are nested and secured with one or more locking pins or squared glands. The inner member and intermediate member are locked in a position such that they are extended outward past one end of the outer nestable member to form a pool cue shaft. At the opposite end of the extended members, a pool cue head is operably coupled to the nested members using a fastening mechanism, like a locking pin aligned through the apertured faces of the members, and thus forming a pool cue of adjustable length.

A feature and advantage of embodiments of the invention is the ability to form an adjustable length mirror holder with light mount for vehicle inspection. The nestable members are nested and secured with one or more locking pins or squared glands. The inner member and intermediate member are locked in a position such that they are extended outward past one end of the outer nestable member to form an elongated handle. Alternatively, the inner member and intermediate member do not extend past the edge of the outer nestable member to form a shorter handle. At the opposite end of the extended members, a mirror is operably coupled to the nested members using a fastening mechanism, like a locking pin aligned through the apertured faces of the members. An optional mount comprising orthogonally disposed projections that extend orthogonally from the nestable members and parallel to the raised mirror is threaded over the members, secured, and operably coupled to a flashlight. Thus, an inspection mirror capable of nighttime operation is contemplated.

The above summary of the invention is not intended to describe each illustrated embodiment or every implementation or feature of the present invention. The figures and the detailed description that follow more particularly exemplify these embodiments.

### BRIEF DESCRIPTION OF THE DRAWINGS

FIG. 1 is a perspective view of the multi-purpose tool of the present invention with an accessory support member in a transport mode, according to an embodiment;

FIG. 2 is an exploded view of the multi-purpose tool of FIG. 1;

FIG. 3 is a perspective view of the multi-purpose tool of the present invention with an accessory support member in a transport mode, according to an embodiment;

FIG. 4 is a top view of the multi-purpose tool of the present invention with a locking mechanism shown in phantom to reveal rotation, according to an embodiment;

FIG. 5 is a side view of the multi-purpose tool of the present invention with nestable members shown extending, according to an embodiment;

FIG. 6a is a perspective view of the multi-purpose tool of the present invention configured as a camping chair, according to an embodiment;

FIG. 6b is a top view of the member locking disc of FIG. 6a.

FIG. 6c is a cross-sectional view taken at section E-E of FIG. 6b;

FIG. 7 is a perspective view of the multi-purpose tool of the present invention configured as a shower bag hanger, according to an embodiment;

FIG. 8 is a perspective view of the multi-purpose tool of the present invention configured as a saw and utilizing two accessory support members, according to an embodiment;

FIG. 9 is a perspective view of the multi-purpose tool of the present invention configured as a pitchfork, according to an embodiment;

FIG. 10 is a perspective view of the multi-purpose tool of the present invention configured as a hoe or shovel, according to an embodiment;

FIG. 11 is a perspective view of the multi-purpose tool of the present invention configured as an oar or paddle, according to an embodiment;

FIG. 12 is a perspective view of the multi-purpose tool of the present invention configured as a pool cue, according to an embodiment;

FIG. 13 is a perspective view of the multi-purpose tool of the present invention configured as a camera stand, according to an embodiment;

FIG. 14 is a perspective view of the multi-purpose tool of the present invention configured as a fishing net, according to an embodiment;

FIG. 15 is a perspective view of two multi-purpose tools of the present invention configured as a minnow seine, according to an embodiment;

FIG. 16 is a perspective view of the multi-purpose tool of the present invention configured as a bow rack, according to an embodiment;

FIG. 17 is a perspective view of the multi-purpose tool of the present invention configured as a deer drag, according to an embodiment;

FIG. 18 is a perspective view of the multi-purpose tool of the present invention configured as a walking stick, according to an embodiment;

FIG. 19 is a perspective view of the multi-purpose tool of the present invention configured as a fishing rod holder, according to an embodiment;

FIG. 20 is a perspective view of the multi-purpose tool of the present invention configured as a grill stand, according to an embodiment;

FIG. 21a is a perspective view of the grill grate of FIG. 20;

FIG. 21b is a side view of the grill grate of FIG. 21a;

FIG. 21c is a side view of the grill grate of FIG. 21a with a first outer section shown in phantom to reveal the first outer section fold;

FIG. 21d is a side view of the grill grate of FIG. 21a with a second outer section shown in phantom to reveal the second outer section fold, when the first outer section has already been folded;

FIG. 21e is a side view of the grill grate of FIG. 21a with a second inner section and a second outer section shown in phantom to reveal the inner section fold, when the first outer section has already been folded;

FIG. 21f is a side view of the grill grate of FIG. 21a with all sections folded and in a transport position;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

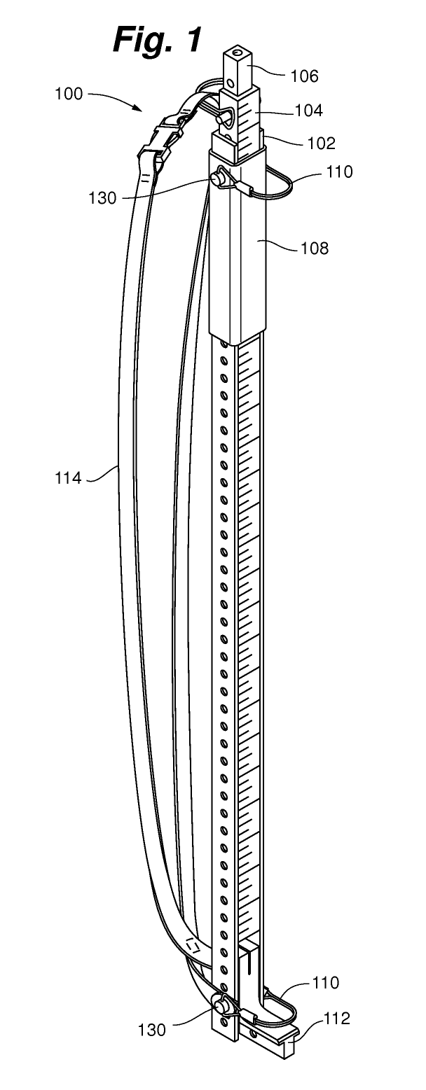

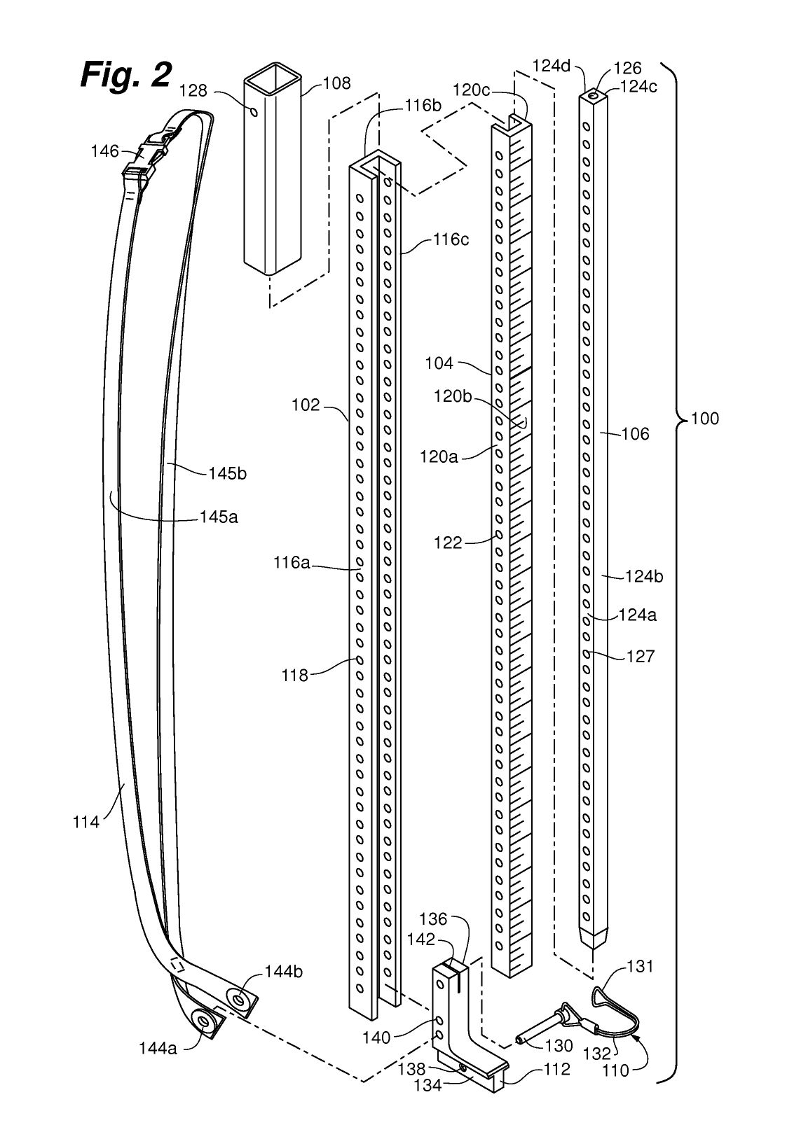

As depicted in FIGS. 1-2, tool 100 generally includes outer elongated member 102, intermediate elongated member 104, inner elongated member 106, and locking mechanism 110.

Outer elongated member 102 is substantially U-shaped and comprises rearwall 116b, first sidewall 116a, and second sidewall 116c. First sidewall 116a extends orthogonally from rearwall 116b at one end of rearwall 116b. Similarly, second sidewall 116c extends orthogonally from rearwall 116b, but from the opposite side as first sidewall 116a. First sidewall 116a has a face having a plurality of apertures 118 spaced equidistant from each other. Second sidewall 116c has a face having a plurality of identically spaced apertures 118 as first sidewall 116a. In another embodiment, apertures 118 along first sidewall 116a and second sidewall 116c are positioned at varying lengths. Rearwall 116b has a continuous face.

Intermediate elongated member 104 is also substantially U-shaped and comprises rearwall 120b, first sidewall 120a, and second sidewall 120c. First sidewall 120a extends orthogonally from rearwall 120b from one side of rearwall 120b. Similarly, second sidewall 120c extends orthogonally from rearwall 120b, but from the opposite side as first sidewall 120a. First sidewall 120a has a face having a plurality of apertures 122 spaced equidistant from each other. Second sidewall 120c has a face having a plurality of identically spaced apertures 122 as first sidewall 120a. In another embodiment, apertures 122 along first sidewall 120a and second sidewall 120c are positioned at varying lengths. Rearwall 120b has a continuous face.

Inner elongated member 106 is substantially square-shaped and comprises first sidewall 124a, second sidewall 124b, third sidewall 124c, and fourth sidewall 124d. First sidewall 124a extends orthogonally from one side of fourth sidewall 124d. Second sidewall 124b extends orthogonally from first sidewall 124a from the side not connected to fourth sidewall 124d. Third sidewall 124c extends orthogonally from second sidewall 124b from the side not connected to to first sidewall 124a. Fourth sidewall extends orthogonally from third sidewall 124c from the side not connected to second sidewall 124b. Thus, sidewalls 124a, 124b, 124c, and 124d connect to form a square where first sidewall 124a and third sidewall 124c are opposite each other, and second sidewall 124b and fourth sidewall 124d are opposite each other. Aperture 126 runs throughout the longitudinal axis created by the four sidewalls 124a, 124b, 124c, and 124d. First sidewall 124a has a face having a plurality of apertures 127 spaced equidistant from each other. Third sidewall 124c has a face having a plurality of identically spaced apertures 127 as first sidewall 124a. In another embodiment, apertures 127 along first sidewall 124a and third sidewall 124c are positioned at varying lengths. Sidewalls 124b and 124d have continuous faces. In another embodiment, sidewalls 124b and 124d have apertured faces identical to the faces of sidewalls 124a and 124c. In still another embodiment, sidewalls 124b and 124d have apertured faces with apertures 127 spaced differently than the spacing of apertures 127 along sidewalls 124a and 124c.

Outer elongated member 102, intermediate elongated member 104, and inner elongated member 106 are substantially the same length and nestable such that, when nested, the three elongated members 102, 104, and 106 are coaxial along a shared longitudinal axis. Inner member 106 nests in a coaxial relationship within U-shaped intermediate member 104. The interior dimensions of intermediate member 104 are shaped just larger than the outside dimensions of inner member 106 such that each of the respective inner sides of intermediate member 104 make flush contact with a respective outside side of inner member 106. For example, the interior side of intermediate member first sidewall 120a makes flush contact with the outside side of inner member first sidewall 124a, the interior side of intermediate member rearwall 120b makes flush contact with the outside side of inner member second sidewall 124b, and the interior side of intermediate member second sidewall 120c makes flush contact with the outside side of inner member third sidewall 124c.

The nested combination of inner member 106 and intermediate member 104 can further nest in a coaxial relationship within U-shaped outer member 102. The interior dimensions of outer member 102 are shaped just larger than the outside dimensions of the nested combination of intermediate member 104 and inner member 106 such that each of the respective inner sides of outer member 102 make flush contact with a respective outside side of intermediate member 104 or inner member 106. The nested combination of inner member 106 and intermediate member 104 fits in outer member 102 such that inner member 106 is enclosed between the walls of outer member 102 and intermediate member 104. For example, the interior side of outer member first sidewall 116a makes flush contact with the outside side of intermediate member first sidewall 120a, the interior side of outer member rearwall 116b makes flush contact with the outside side of inner member fourth sidewall 124d, and the interior side of outer member second sidewall 116c makes flush contact with the outside side of intermediate member second sidewall 120c.

Outer elongated member 102 and intermediate elongated member 104 are further slidingly receivable with inner member 106 so as to extend the length of the tool 100 along the collinear longitudinal axis shared by members 102, 104, and 106. In an exemplary embodiment, the spacing of apertures 118 along outer member first sidewall 116a and outer member second sidewall 116c, as well as the spacing of apertures 122 along intermediate member first sidewall 120a and intermediate member second sidewall 120b, and the spacing of apertures 127 along inner member first sidewall 124a and inner member third sidewall 124c are identically spaced, whether equidistant or of varying lengths. Because of the nestability and sliding receivability of inner elongated member 106 into intermediate elongated member 104 and outer elongated member 102, apertures 118, 122, and 127 can align to form a tool 100 of different lengths. At least some of the plurality of apertures 118 of outer member 102 align with at least some of the plurality of apertures 122 of intermediate member 104 and at least some of the plurality of apertures 127 of inner member 106 when members 102, 104, and 106 are nested such that a pin, engaging device, or locking mechanism can extend therethrough.

An exemplary locking mechanism 110 is depicted in FIGS. 1-3. Locking mechanism 110 generally includes pin 130 and clevis 132. Clevis 132 extends from the head of pin 130 in a substantially U-shape and is rotatable about an axis perpendicular to the longitudinal axis of pin 130. Clevis 132 contains aperture 131 for accepting pin 130. Clevis 132 is substantially rigid, but malleable enough to position the tail of pin 130 into aperture 131 such that pin 130 is received by aperture 131, or to remove pin 130 from aperture 131. Pin 130 can be positioned, for example, through a set of apertures 118, 122, and 127. Once so positioned, clevis 132 is rotated and positioned such that aperture 131 receives the tail of pin 130, thus locking entire locking mechanism 110 along with members 102, 104, and 106, in place.

Optionally, tool 100 can include squared gland 108. Squared gland 108 includes apertures 128 located at identical positions on opposite-facing walls so as to also receive a pin 130 of locking mechanism 110. The interior dimensions of squared gland 108 are shaped just larger than the outside dimensions of nested members 102 and 104 such that each of the respective inner sides of squared gland 108 make flush contact with a respective outside side of nested members 102 and 104. As such, squared gland 108 provides additional force compressing inner member 106 within outer member 102 and intermediate member 104, thus further securing nested members 102, 104, and 106.

Optionally, as depicted generally in FIGS. 1-2, tool 100 can include strap 114. Strap 114 generally includes strap first portion 145a, strap second portion 145b, and buckle 146. Buckle 146 is operably coupled to strap first portion 145a on one end, and operably coupled to strap second portion 145b on an oppositee end such that strap first portion 145a and strap second portion 145b can be coupled or uncoupled using buckle mechanism 146 when desired. Strap first portion 145a contains attaching aperture 144a at the end opposite buckle 146 for operably coupling strap first portion 145a to any or all of nesting members 102, 104, and 106, for example, by utilizing locking mechanism 110. Similarly, strap second portion 145b contains attaching aperture 144b at the end opposite buckle 146 for operably coupling strap second portion 145b to any or all of nesting members 102, 104, and 106.

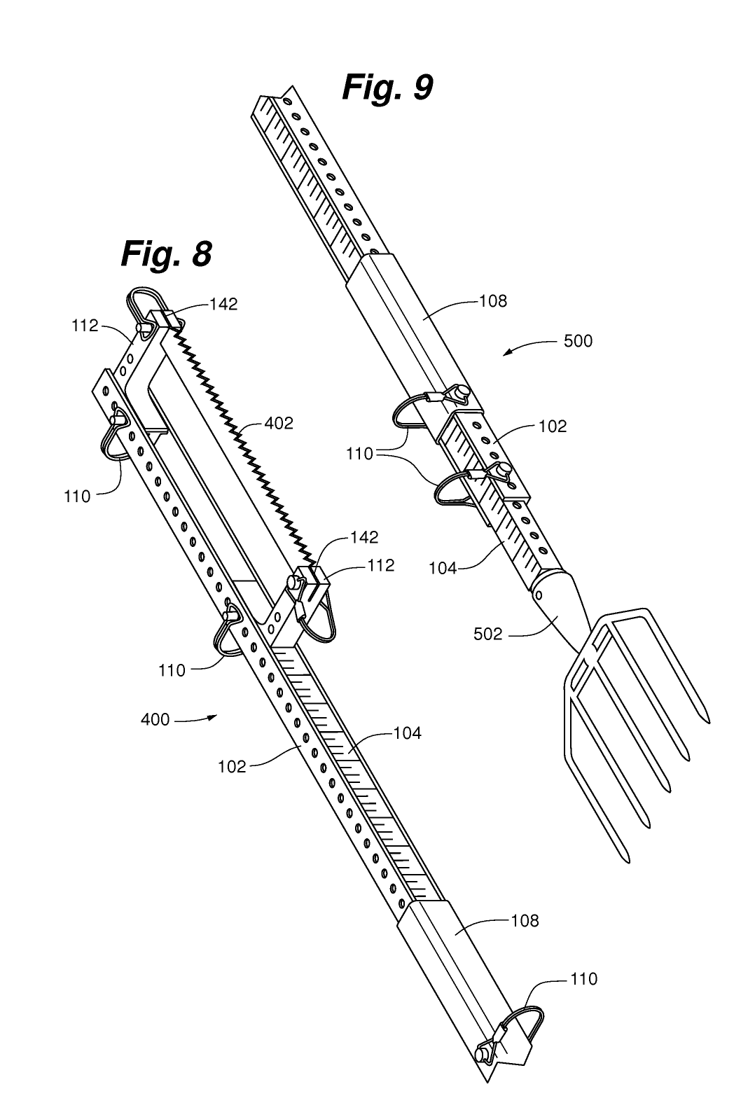

Optionally, tool 100 can include one or more accessory support members for supporting various tool attachments or application-specific heads. In an embodiment, an accessory support member 112 is L-shaped. Shown in a transport, non-operational position in FIGS. 1-2, accessory support member 112 has a first projection 136 that nests within the interior volume of outer member 102, and a second projection 134 that extends orthogonally from first projection 136. Slot 142 on the distal end of first projection 136 is able to receive a saw blade attachment. In an embodiment, both projections 134 and 136 have apertures for receiving locking mechanisms 110. As shown, first projection 136 contains apertures 140 that extend through the bulk of first projection 136 and are positioned at varying lengths. In another embodiment, apertures 140 are identically spaced along first projection 136. Similarly, second projection 134 contains aperture 138 for receiving locking mechanisms 110. In another embodiment, second projection 134 has a plurality of apertures 138. By utilizing the L-shape, accessory support member 112 can have a first projection 136 for supporting one type of accessory while second projection 134 is nested and provides the apertures for the locking mechanism. Conversely, when accessory support member 112 is rotated such that second projection 134 is extended orthogonally from the nested members 102, 104 and 106, second projection 134 can provide support for a second type of accessory while first projection 136 is nested and provides the apertures for the locking mechanism. Referring to FIG. 8, two accessory support members 112 are shown in use as supporting a saw blade.

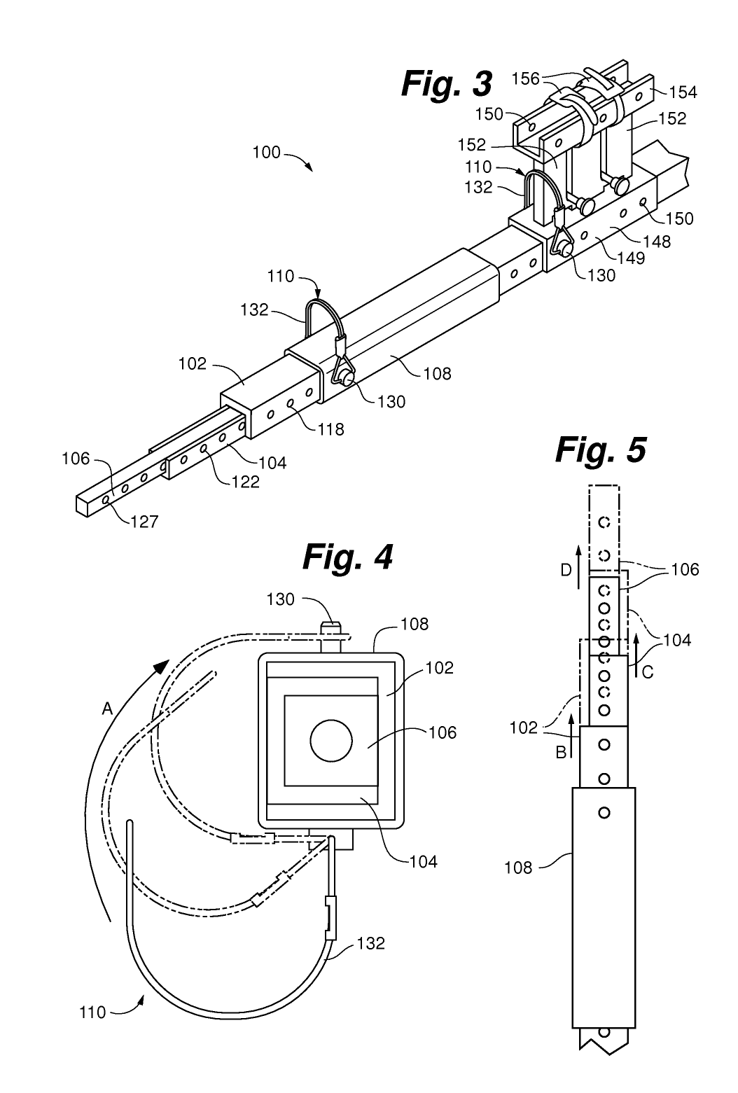

In another embodiment, referring to FIG. 3, an accessory support member is mountable on an outside side of nested members 102, 104, and 106, rather than within the interior volume of one of the nested members 102, 104, or 106. In an embodiment, accessory support member 148 contains base 149, a plurality of orthogonally disposed projections 152 projecting from base 149, and substantially U-shaped housing 154 extends from the top of orthogonally disposed projections 152 for housing an accessory. Optionally, accessory support member 148 can contain Velcroed accessory straps 156 for coupling accessories to housing 154. Base 149 can be substantially U-shaped, as shown in FIG. 3, such that the interior dimensions of the three walls of base 149 are shaped just larger than the outside dimensions of nested members 102 and 104 such that each of the respective three inner sides of base 149 make flush contact with a respective outside side of nested members 102 and 104. Alternatively, base 149 may be a squared gland such that the interior dimensions of a fourth wall is shaped just larger than the outside dimension of the non-contacted outer wall of nested members 102 and 104 in the U-shaped embodiment to fully enclose nested members 102 and 104. Base 149 has two opposite faces containing apertures 150 that extend collinear with the apertures on the respective faces of nested members 102, 104, and 106. At least some of the plurality of apertures 150 align with at least some of the plurality of apertures 118 of outer member 102, with at least some of the plurality of apertures 122 of intermediate member 104 and at least some of the plurality of apertures 127 of inner member 106 when members 102, 104, and 106 are nested such that a pin, engaging device, or locking mechanism can extend therethrough. As such, a single locking mechanism 110 can lock accessory support member 148 and nested members 102, 104, and 106. Orthogonally disposed projections 152 project from base 149 to provide some distance from the longitudinal axis of nested members 102, 104, and 106 in the case where an accessory requires it. Housing 154 extends from orthogonally disposed projections 152 and can house any number of accessories. Further, housing 154 contains two opposite faces containing additional apertures 150 to be used for securing attachments or accessories, or intermediate member 104 or inner member 106.

In operation, generally, in an extended, nested configuration, referring to FIGS. 4-5, inner member 106 and intermediate member 104 are nested within outer member 102 as described in a nested configuration above. Outer member 102 is positioned relative to squared gland 108 at position B, in the case where a squared gland is desired. Intermediate member 104 can be extended at position C from outer member 102. Inner member 106 can be extended at position D from intermediate member 104. Extensions and positioning at positions B, C, and D can be made until a total length and respective placement of nested member 102, 104, and 106 is reached for the appropriate application for tool 100. Further, extensions and positioning can be made while tool is being used, in certain applications.

Once so positioned and extended, members 102, 104, and 106 are locked in place. FIG. 4 illustrates a locking utilizing a pin 130 and clevis 132. Pin 130 is inserted through the plurality of aligned apertures of squared gland 108, outer member 102, intermediate member 104, and inner member 106. Clevis 132 is rotated from the head of pin 130 in direction A such that aperture 131 of clevis 132 locks with the tail of pin 130 to secure nested members 102, 104, and 106, and squared gland 108. Depending on the positioning of intermediate member 104 and inner member 106, additional locking mechanisms 110 may be required or desired. For example, inner member 106 may be extended such that there is no overlap between inner member 106 and outer member 102, only with inner member 106 and intermediate member 104. In such a case, two locking mechanisms 110 may be required—one locking mechanism 110 to secure intermediate member 104 to outer member 102, and a second locking mechanism 110 to secure inner member 106 to intermediate member 104.

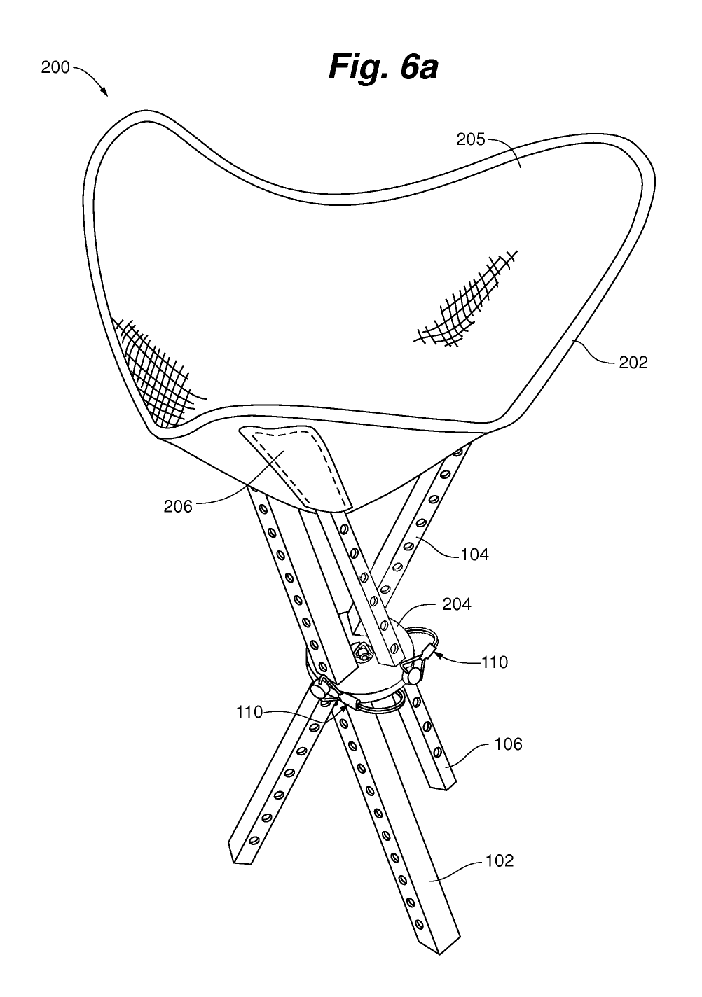

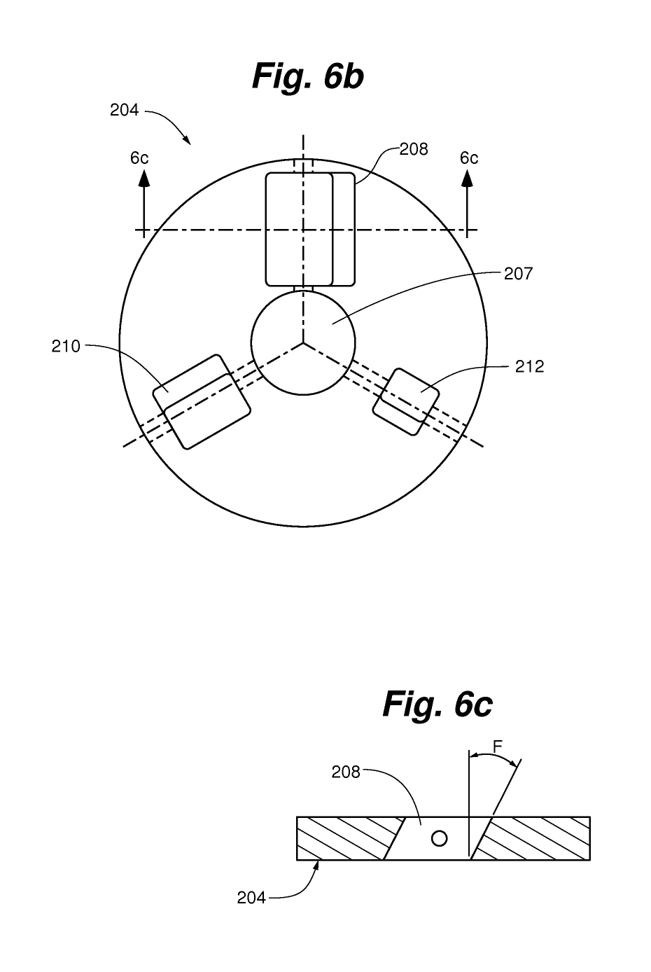

Additional accessories and attachments are considered, depending on the application and configuration of the tool. Referring to FIGS. 6a-6c, an embodiment configured as a camping chair is illustrated. Camping chair 200 generally includes seat 202, interlocking disc 204, unnested outer member 102, unnested intermediate member 104, unnested inner member 106, and a plurality of locking mechanisms 110. Seat 202 comprises base portion 205 that is typically made of soft cloth, substantially triangular-shaped and used for receiving a sitting human. The opposite side of base portion 205 contains three receiving pockets 206 for receiving each of the unnested members 102, 104, and 106. Interlocking disc 204 contains center aperture 207, aperture 208 for receiving outer member 102, aperture 210 for receiving intermediate member 104, and aperture 212 for receiving inner member 106. Referring specifically to FIGS. 6b and 6c, the interior dimensions of apertures 208, 210 and 212 of interlocking disc 204 are angled and are shaped just larger than the outside dimensions of the respective unnested member the apertures are intended to receive such that when the respective unnested members 102, 104, and 106 are received through apertures 208, 210, and 212, respectively, each of the respective inner sides of apertures 208, 210, and 212 make flush contact with a respective outside side of the respective unnested members 102, 104, and 106. For example, in the cross section along E-E as illustrated in FIG. 6c, aperture 208 is angled distance F away from perpendicular. Apertures 208, 210, and 212 are thus shaped substantially like parallelograms. Further, interlocking disc 204 contains an pin-sized aperture running from the circumferential sidewall to the center aperture 207 for each of the apertures 208, 210, and 212.

In operation in an unnested, chair configuration as illustrated in FIGS. 6a-6c, outer member 102 is positioned through aperture 208 of interlocking disc 204, intermediate member 104 is positioned through aperture 210 of interlocking disc 204, and inner member 106 is positioned through aperture 212 of interlocking disc 204. Interlocking disc 204 is then slid intermediate the unnested members 102. Three locking mechanisms 110 are utilized for securing each of the nested members 102, 104, and 106 to the interlocking disc through center aperture 207. For each unnested member 102, 104, and 106, pin 130 of a respective locking mechanism 110 is inserted from the circumferential sidewall through interlocking disc 204, through the respective unnested member 102, 104, and 106, such that the tail of pin 130 enters center aperture 207. The respective clevis 132 of each locking mechanism 110 is rotated such that it locks the tail of pin 130 at the center aperture 207. Once three locking mechanisms 110 secure outer member 102, intermediate member 104, and inner member 106 to interlocking disc as described, a stabilized base is formed. Finally, the base portion 205 of seat 202 is positioned such that each of the unnested members 102, 104, and 106 are adjacent their respective receiving pockets 206. Once unnested members 102, 104, and 106 are inserted into the respective receiving pockets 206, a chair is formed.

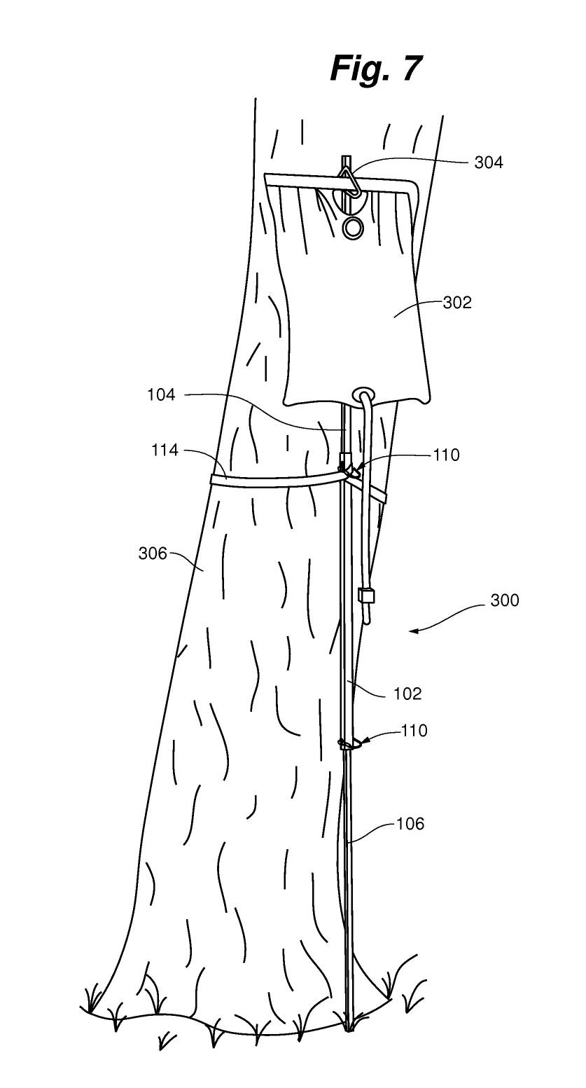

Referring to FIG. 7, an embodiment configured as a shower bag hanger is illustrated. Shower bag hanger 300 generally includes shower bag 302, carabiner 304, strap 114, and outer member 102, intermediate member 104, and inner member 106 configured as a nested extension as described above. In operation as shower bag hanger 300, nested members 102, 104, and 106 are extended and locked as described above at a height appropriate for hanging shower bag 302. Strap 114 is wrapped around a tree 306 such that strap first portion 145a and strap second portion 145b are taut and coupled intermediate the extended members 102, 104, and 106 so that the extended members 102, 104, and 106 stand upright. Carabiner 304 is secured at the distal end of extended members 102, 104, and 106. Shower bag 302 is hooked or operably coupled to carabiner 304 or other hooking mechanism, thus forming a shower bag hanger.

Referring to FIG. 8, an embodiment configured as a saw is illustrated. Saw 400 generally includes saw blade 402, two L-shaped accessory support members 112, at least four locking mechanisms 110, and outer member 102, intermediate member 104, and inner member 106 configured as a nested extension as described above. Saw blade 402 contains apertures at each end for receiving a locking mechanism 110. Optionally, and as shown, saw 400 may include squared gland 108 and an additional locking mechanism 110 to act as the saw 400 handle or grip. In operation, as saw 400, nested members 102, 104, and 106 are extended and locked as described above at a length appropriate for the particular sawing application. Intermediate member 104 is receded an appropriate length to accommodate the two L-shaped accessory support members 112 and saw blade 402. Once so positioned, a first accessory support member 112 is positioned at a distal end of the outer member 102 with one projection positioned within the interior volume of outer member 102 and secured to outer member 102 with locking mechanism 110. A second accessory support member 112 is positioned at a distance from first accessory support member 112 to accommodate the desired saw blade, and likewise attached with a second locking mechanism 110. Saw blade 402 is inserted within slots 142 of accessory support members 112 and secured at each end with a locking mechanism 110. Optionally, a handle is placed and secured at an appropriate location along extended members 102, 104, and 106 with a squared gland 108 and locking mechanism 110. Thus, a saw is formed.

Referring to FIG. 9, an embodiment configured as a pitchfork is illustrated. Pitchfork 500 generally includes pitchfork head 502, at least one locking mechanism 110, and outer member 102, intermediate member 104, and inner member 106 configured as a nested extension as described above. Pitchfork head 502 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, pitchfork 500 may include squared gland 108 and an additional locking mechanism 110 to act as the pitchfork 500 handle or grip. In operation as pitchfork 500, nested members 102, 104, and 106 are extended and locked as described above at a length appropriate for using a pitchfork. Once so positioned, locking mechanism 110 is inserted to lock all of nested members 102, 104, and 106, as well as pitchfork head 502. Thus, a pitchfork is formed.

Referring to FIG. 10, an embodiment configured as a hoe or shovel is illustrated. Hoe 600 generally includes hoe head 602, at least one locking mechanism 110, and outer member 102, intermediate member 104, and inner member 106 configured as a nested extension as described above. Hoe head 602 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, hoe 600 may include squared gland 108 and an additional locking mechanism 110 to act as the hoe 600 handle or grip. In operation as hoe 600, nested members 102, 104, and 106 are extended and locked as described above at a length appropriate for using a hoe. Once so positioned, locking mechanism 110 is inserted to lock all of nested members 102, 104, and 106, as well as hoe head 602. Thus, a hoe or shovel is formed.

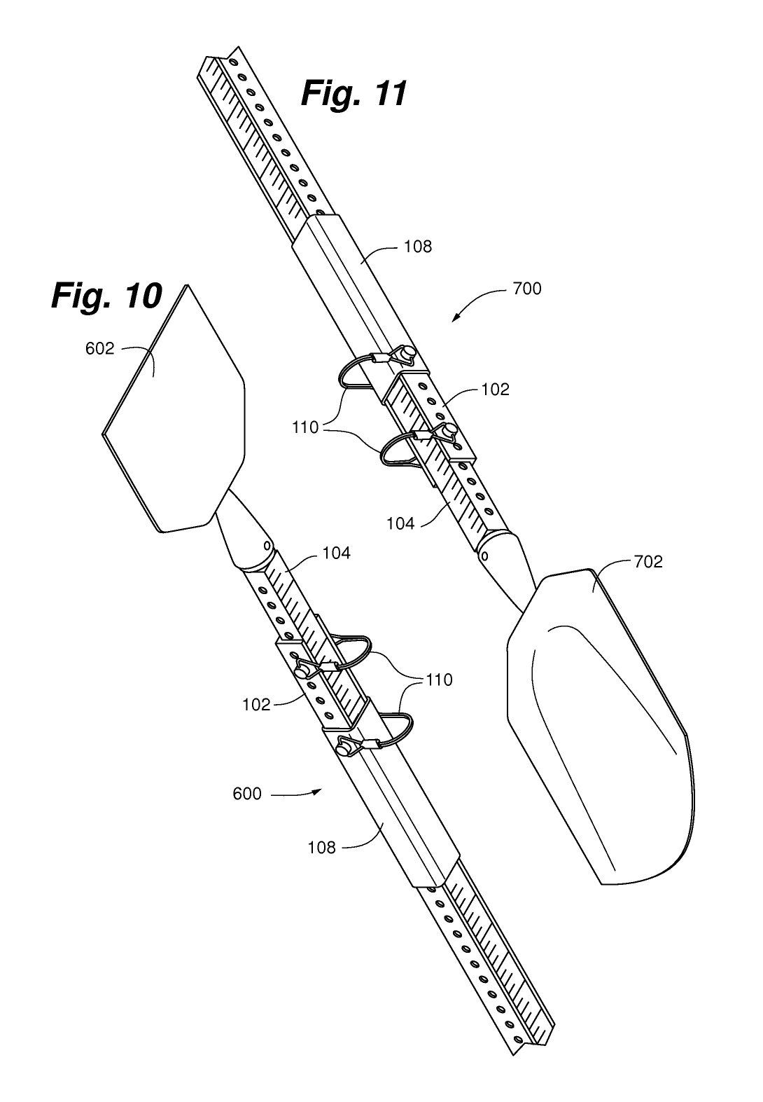

Referring to FIG. 11, an embodiment configured as an oar or paddle is illustrated. Oar 700 generally includes oar head 702, at least one locking mechanism 110, and outer member 102, intermediate member 104, and inner member 106 configured as a nested extension as described above. Oar head 702 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, oar 700 may include squared gland 108 and an additional locking mechanism 110 to act as the oar 700 handle or grip. In operation as oar 700, nested members 102, 104, and 106 are extended and locked as described above at a length appropriate for using an oar. Once so positioned, locking mechanism 110 is inserted to lock all of nested members 102, 104, and 106, as well as oar head 702. Thus, an oar is formed.

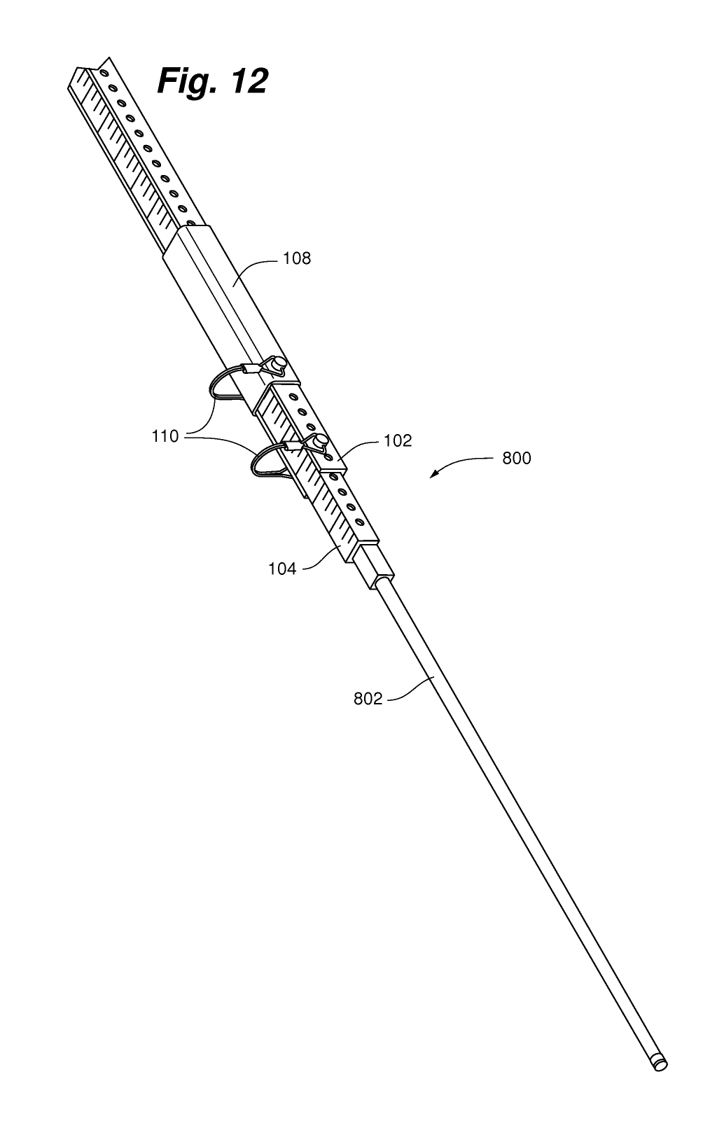

Referring to FIG. 12, an embodiment configured as a pool cue is illustrated. Pool cue 800 generally includes pool cue head 802, at least one locking mechanism 110, and outer member 102, intermediate member 104, and inner member 106 configured as a nested extension as described above. Pool cue head 802 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, pool cue 800 may include squared gland 108 and an additional locking mechanism 110 to act as the pool cue 800 handle or grip. In operation as pool cue 800, nested members 102, 104, and 106 are extended and locked as described above at a length appropriate for using a pool cue. Once so positioned, locking mechanism 110 is inserted to lock all of nested members 102, 104, and 106, as well as pool cue head 802. Thus, a pool cue is formed.

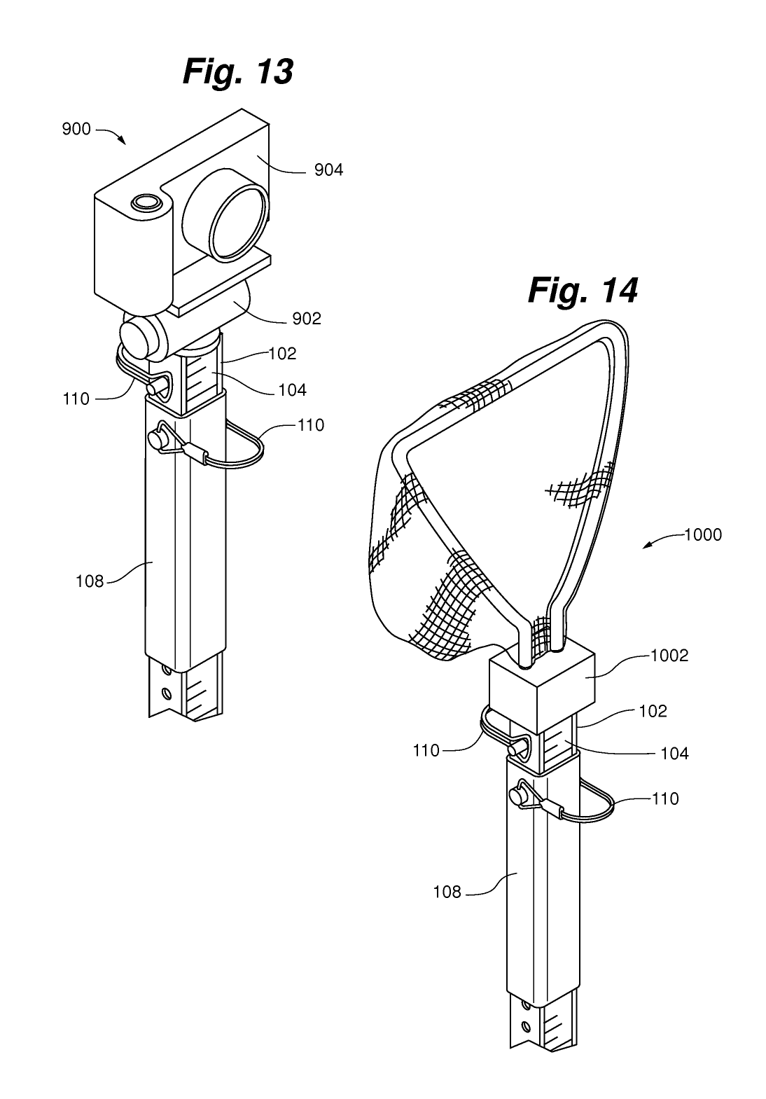

Referring to FIG. 13, an embodiment configured as a camera stand is illustrated. Camera stand 900 generally includes camera stand head 902, at least one locking mechanism 110, and outer member 102, intermediate member 104, and inner member 106 configured as a nested extension as described above. Camera stand head 902 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, camera stand 900 may include squared gland 108 and an additional locking mechanism 110 to act as the camera stand 900 handle or grip. In operation as camera stand 900, nested members 102, 104, and 106 are extended and locked as described above at a length appropriate for using a camera stand. Once so positioned, locking mechanism 110 is inserted to lock all of nested members 102, 104, and 106, as well as camera stand head 902. Camera 904 can then be mounted to camera stand head 902. Thus, a camera stand is formed.

Referring to FIG. 14, an embodiment configured as a hand fishing net is illustrated. Fishing net 1000 generally includes fishing net head 1002, at least one locking mechanism 110, and outer member 102, intermediate member 104, and inner member 106 configured as a nested extension as described above. Fishing net head 1002 contains an apertured, elongated section (not shown) for inserting into aperture 126 of inner member 106. The elongated section is substantially rounded and shaped just smaller than the dimensions of aperture 126 such that the respective outer sides of the elongated section make flush contact with the respective sides of aperture 126. The apertures of the elongated section are spaced such that at least some of the apertures align with the apertures of nested members 102, 104, and 106. Optionally, and as shown, fishing net 1000 may include squared gland 108 and an additional locking mechanism 110 to act as the fishing net 1000 handle or grip. In operation as fishing net 1000, nested members 102, 104, and 106 are extended and locked as described above at a length appropriate for using a fishing net. Once so positioned, locking mechanism 110 is inserted to lock all of nested members 102, 104, and 106, as well as fishing net head 1002. Thus, a fishing net is formed.

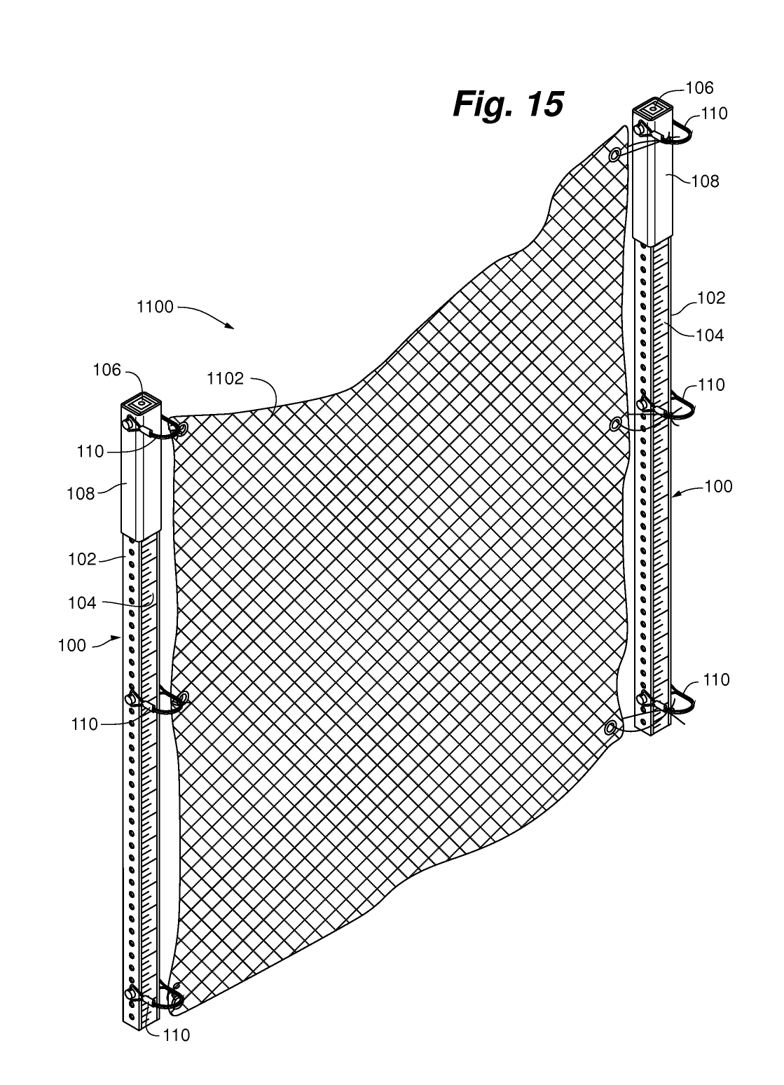

Referring to FIG. 15, an embodiment configured as a minnow seine is illustrated. Minnow seine 1100 generally includes netting 1102, a plurality of locking mechanisms 110, and two tools 100, with outer members 102, intermediate members 104, and inner members 106 in each of the two tools 100 configured as nested and either extended or retracted, as described above, as is appropriate for the length of netting 1102. Optionally, and as shown, minnow seine 1100 may include squared glands 108 and additional locking mechanisms 110 to act as the fishing net 1000 handles or grips. In operation as minnow seine 1100, nested members 102, 104, and 106 are extended or retracted and locked as described above at a length appropriate for the length of netting 1102. Once so positioned, locking mechanisms 110 are inserted to lock all of nested members 102, 104, and 106 in each of the respective tools 100. In the embodiment shown, each tool 100 is secured with three locking mechanisms 110, spaced equidistant from each other. The clevis 132 of each locking mechanism is used for operably coupling netting 1102 to tool 100, for example, by threading clevis 132 through an eyelet of netting 1102 before locking with pin 130. By securing netting 1102 at equidistant spacings along tool 100, a sturdy seine is formed.

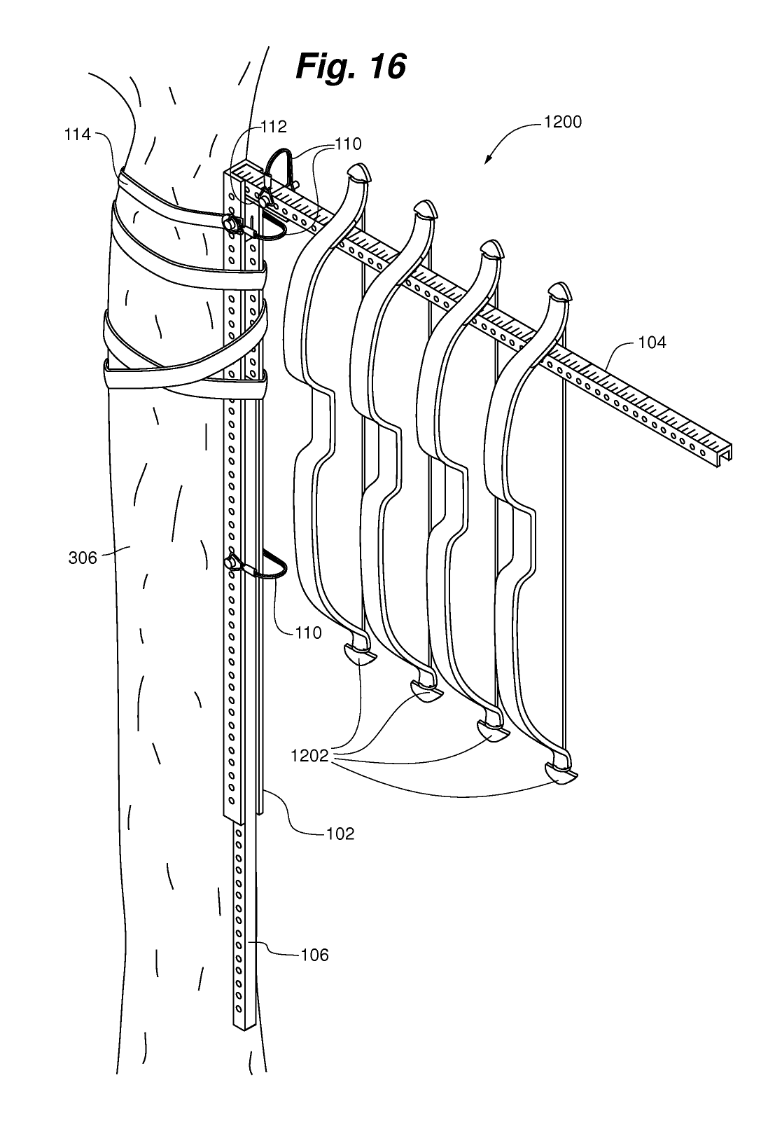

Referring to FIG. 16, an embodiment configured as a bow rack is illustrated. Bow rack 1200 generally includes L-shaped accessory support member 112, outer member 102, intermediate member 104, strap 114, and at least two locking mechanisms 110. Optionally, inner member 106 and an additional locking mechanism 110 can be utilized for additional support. In operation as bow rack 1200, outer member 102 is coupled to intermediate member 104 using L-shaped accessory support member 112 and locking mechanisms 110 on each of outer member 102 and intermediate member 104 such that intermediate member 104 forms a cantilevering projection. Strap 114 is wrapped around tree 306 such that strap first portion 145a and strap second portion 145b are taut and coupled to outer member 102 such that tree 304 and outer member 102 have parallel longitudinal axes, where rearwall 116b of outer member 102 makes flush contact with the outside side of tree 306. Bows 1202 can then be hung from now-cantilevering intermediate member 104. Optionally, inner member 106 can be extended from outer member 102 and locked by locking mechanism 110 in a manner similar to that discussed above to provide additional force against the outside side of tree 306 and therefore additional support to now-cantilevering intermediate member 104.

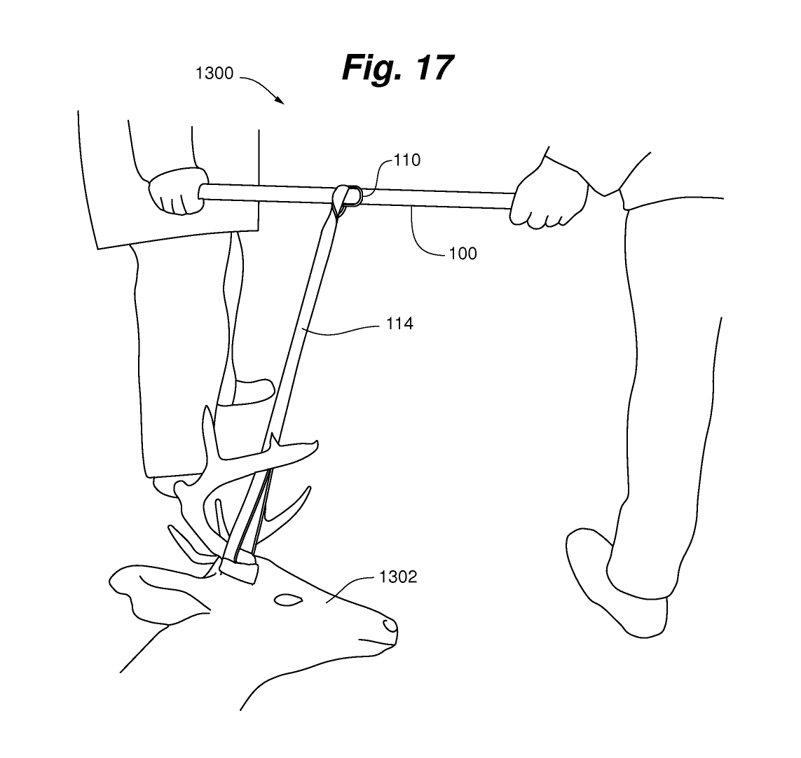

Referring to FIG. 17, an embodiment configured as a deer drag is illustrated. Deer drag 1300 generally includes strap 114, one locking mechanism 114, and one of outer member 102, intermediate member 104, or inner member 106. Optionally, deer drag 1300 can utilize outer member 102, intermediate member 104, and inner member 106, and can be nested and extended or retracted, as described above, depending on the preference of the deer drag 1300 user. In operation as deer drag 1300, strap 114 is coupled intermediate the length of tool 100 to form a loop. The opposite end of strap 114 loop is operably coupled to the deer 1302, thus forming a deer drag.

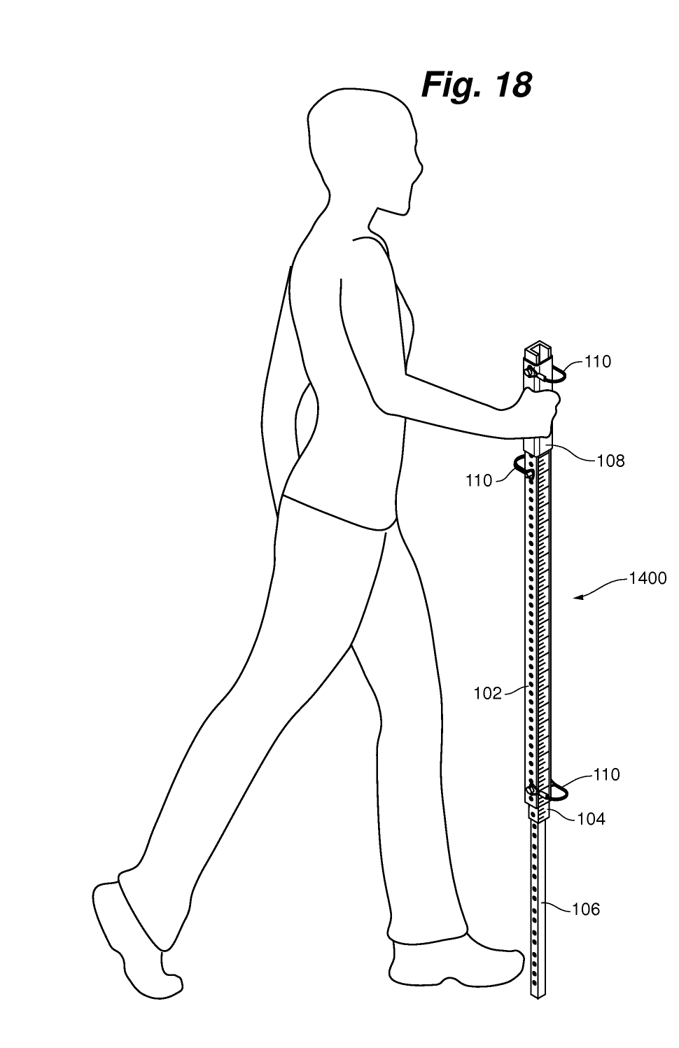

Referring to FIG. 18, an embodiment configured as a walking stick is illustrated. Walking stick 1400 generally includes at least two locking mechanisms 110, and outer member 102, intermediate member 104, and inner member 106 configured as a nested extension as described above. Optionally, and as shown, walking stick 1400 may include squared gland 108 and an additional locking mechanism 110 to act as the walking stick 1400 handle or grip. In operation as walking stick 1400, nested members 102, 104, and 106 are extended and locked as described above at a length appropriate for using a walking stick for a particular user. Once so positioned, a first locking mechanism 110 is inserted to lock nested outer member 102 to intermediate member 104, and a second locking mechanism 110 is inserted to lock the nested combination of outer member 102 and intermediate member 104 to inner member 106. Thus, a walking stick is formed.

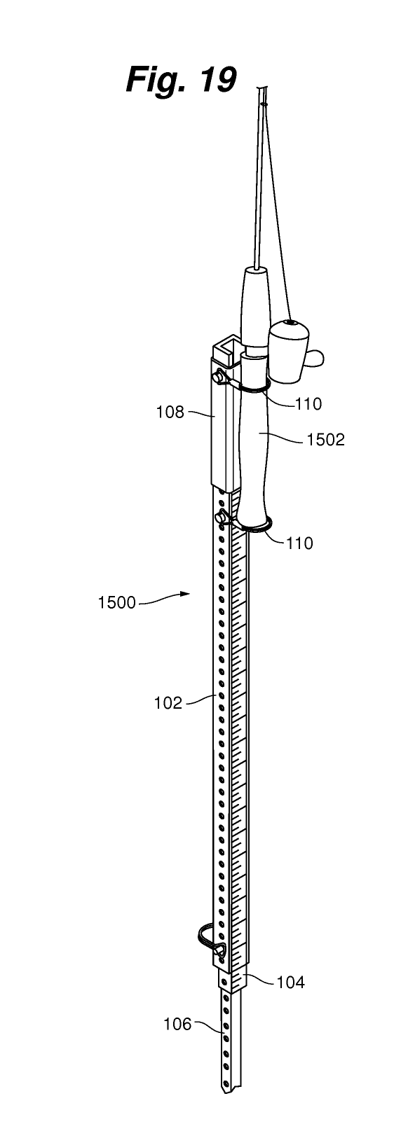

Referring to FIG. 19, an embodiment configured as a fishing rod holder or fishing rod extender is illustrated. Fishing rod holder 1500 generally includes at least two locking mechanisms 110, and outer member 102, intermediate member 104, and inner member 106 configured as a nested extension as described above. Optionally, and as shown, fishing rod holder 1500 may include squared gland 108 and an additional locking mechanism 110 to act as the fishing rod holder 1500 handle or grip. In operation as fishing rod holder 1500, nested members 102, 104, and 106 are extended and locked as described above at a length appropriate for using a fishing rod holder. Once so positioned, the fishing rod 1502 is positioned such that one of the sides of the fishing rod 1502 makes flush contact with the one of the outside sides of nested members 102, 104, and 106 near the distal end of the nested members 102, 104, and 106, and the two have parallel longitudinal axes. One or more clevis 132 of locking mechanisms 110 are rotated about fishing rod 1502 to secure fishing rod 1502 to nested members 102, 104, and 106. The locking mechanisms that securing fishing rod 1502 can also be used to lock nested outer member 102 to intermediate member 104. A second locking mechanism 110 is inserted to lock the nested combination of outer member 102 and intermediate member 104 to inner member 106. Thus, a fishing rod holder is formed.

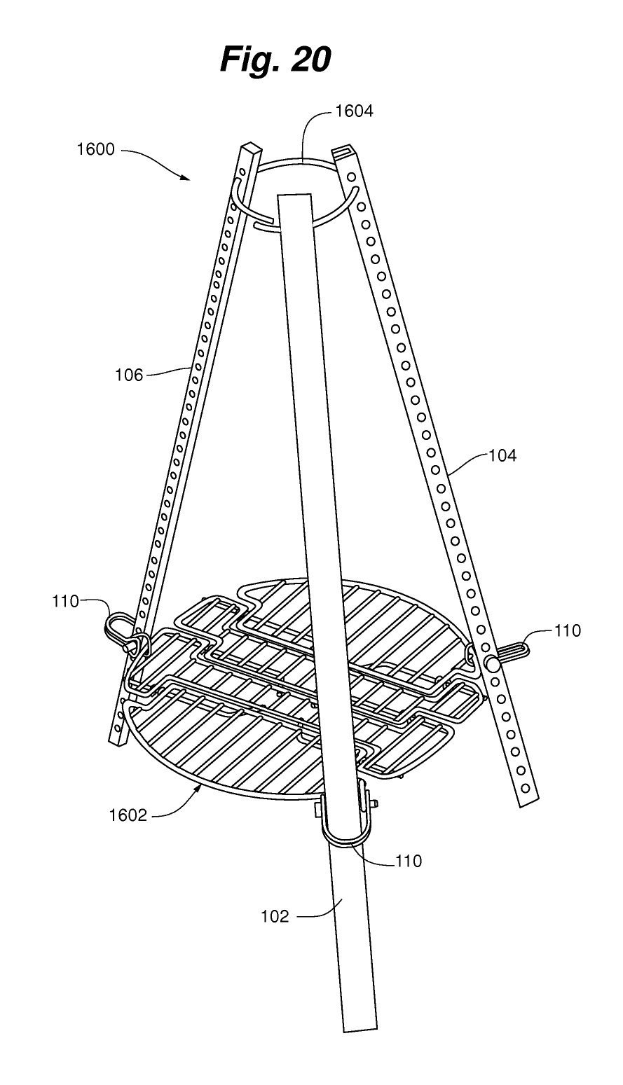

Referring to FIG. 20, an embodiment configured as a grill stand is illustrated. Grill stand 1600 generally includes foldable grill grate 1602, ring 1604, unnested outer member 102, unnested intermediate member 104, unnested inner member 106, and three locking mechanisms 110. In operation as a grill stand 1600, unnested outer member 102, unnested intermediate member 104, unnested inner member 106 are positioned at an acute angle with the ground and equidistant each other to form a circle over a campfire. The unnested members 102, 104, and 106 are operably coupled together at the distal end of each member, for example, with a ring positioned through one of the apertures in each member, thereby forming the grill-mountable sides of a conical grill stand. Because the unnested members 102, 104, and 106 are coupled at the distal end with a ring through apertures, unnested members 102, 104, and 106 can rotate about the ring to create a higher or lower tripod structure. As such, grill grate 1602 can be positioned vertically relative to a campfire at varying heights, thus improving the cooking process. Grill grate 1602 is coupled with locking mechanism 110 at each unnested member 102, 104, and 106 by utilizing the clevis 132 of each locking mechanism 110. Clevis 132 is rotated and hooked to enclose a portion of grill grate 1602 where grill grate 1602 contacts each unnested member 102, 104, and 106.

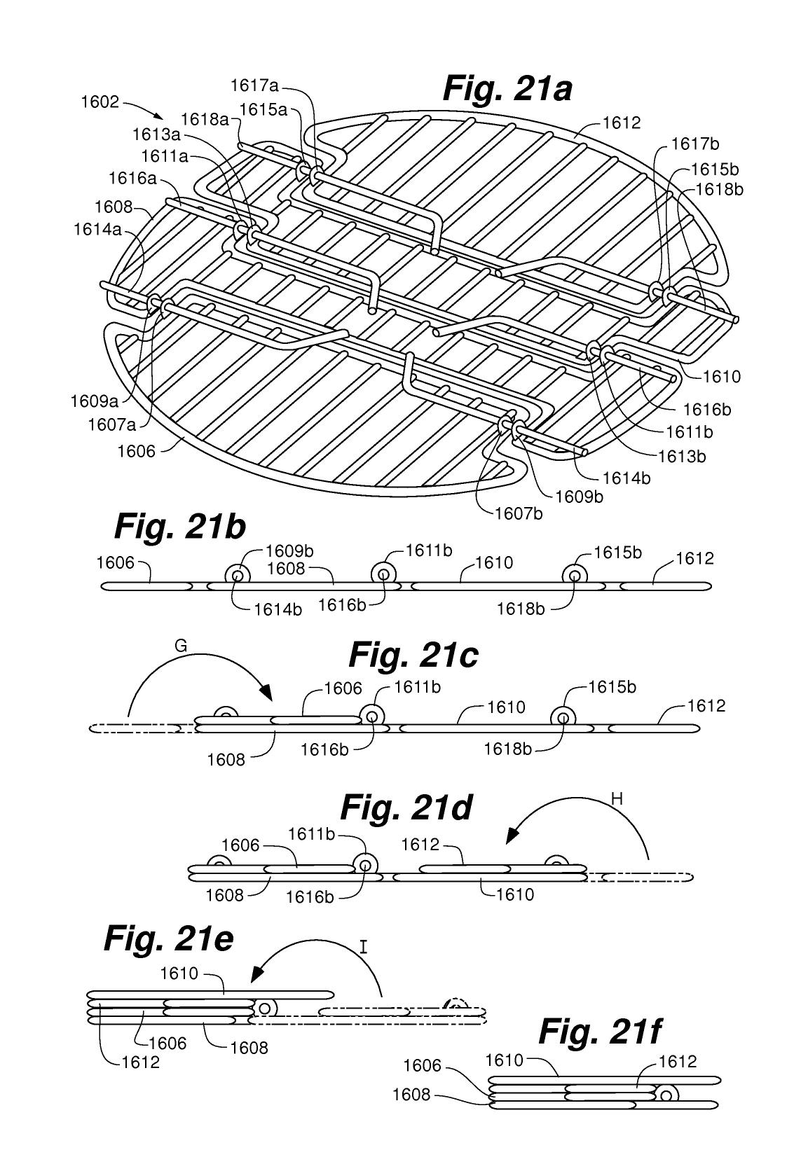

Referring to FIGS. 21a-21f, an embodiment of a foldable grill grate is illustrated. Foldable grill grate 1602 generally includes first outer section 1606, first inner section 1608, second inner section 1610, and second outer section 1612. First outer section 1606 and first inner section 1608 are hingedly coupled with two pins. Pin 1614a is engaged through apertured flange 1609a of first inner section 1608 and apertured flange 1607a of first outer section 1606. Pin 1614b is engaged through apertured flange 1609b of first inner section 1608 and apertured flange 1607b of first outer section 1606. First inner section 1608 and second inner section 1610 are likewise hingedly coupled with two pins. Pin 1616a is engaged through apertured flange 1611a of first inner member 1608 and apertured flange 1613a of second inner member 1610. Pin 1616b is engaged through apertured flange 1611b of first inner member 1608 and apertured flange 1613b of second inner member 1610. Second inner section 1610 and second outer section 1612 are likewise hingedly coupled with two pins. Pin 1618a is engaged through apertured flange 1615a of second inner section 1610 and apertured flange 1617a of second outer section 1612. Pin 1618b is engaged through apertured flange 1615b of second inner section 1610 and apertured flange 1617b of second outer section 1612. Therefore, all of the sections of foldable grill grate 1602 are connected.

In operation, to collapse foldable grill grate 1602 and referring specifically to FIGS. 21b-21e, first outer section 1606 is folded about hinged pins 1614a and 1614b in direction G and therefore foldable onto first inner section 1608. Next, second outer section 1612 is folded about hinged pins 1618a and 1618b in direction H and therefore foldable onto second inner section 1610. Finally, the folded section of second outer section 1612 and second inner section 1610 is foldable about hinged pins 1616a and 1616b in direction I and therefore foldable onto the folded section of first outer section 1606 and first inner section 1608. FIG. 21f shows foldable grill grate 1602 fully collapsed and in a transport position. Unfolding grill grate 1602 simple requires reversing the folds described above to create the usable grate shown in FIGS. 20 and 21a. While the above-described embodiment is illustrated, fewer or more sections, different hinges, or coupling at different points could be designed such that other folding configurations are contemplated. In addition, legs can be coupled to grill grate 1602 to enable a user to place the grill grate 1602 over a campfire or heat source. In a preferred embodiment, grill grate 1602 includes foldable legs that can be collapsed to form a compact configuration as shown in FIG. 21f.

Those skilled in the art will appreciate that the present invention may lend itself to a wide variety of alternative uses. For example, the invention may be used as a support or survey stick by surveying personnel. The invention may also be coupled to a gaff hook for fishing applications. The invention can also be attached to a vehicle and used as a tow bar. In addition, the invention can be used to support a canoe during storage or portaging activity. In an alternative embodiment, the invention can be used as a light hanger or light support. In yet another embodiment, the invention can be coupled to a knife or multi-use tool like those sold by Leatherman Tool Group, Inc. under the LEATHERMAN® trademark. In addition, the strap 114 can be used to form a splint that is useful when providing medical care. Moreover, the present invention can be configured to hold a backpack for hunters while they are keeping lookout in a tree. Additionally, the present invention can be used as a flagpole to support an emergency or distress flag. The present invention can also be used as a mobility crutch, or a ski pole.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A multi-purpose tool capable of operably coupling to at least one application-specific accessory, the multi-purpose tool comprising:
an outer elongated member presenting a first cross-sectional area and a first length;
an intermediate elongated member presenting a second cross-sectional area and a second length, wherein the second cross-sectional area is less than the first cross-sectional area such that the intermediate elongated member is nestable within the outer elongated member;
an inner elongated member presenting a third cross-sectional area and a third length, wherein the third cross-sectional area is less than the first and second cross-sectional areas such that the inner elongated member is nestable within the outer elongated member and the intermediate elongated member,
wherein the outer, inner, and intermediate members are coaxial and the inner elongated member is at least partly enclosed within the outer elongated member and the intermediate elongated member when nested, and
wherein the outer, inner, and intermediate members are shiftable relative to each other to shift the tool between a plurality of tool configurations; and
at least one locking mechanism, the at least one locking mechanism engageable with the outer member, intermediate member, and inner member to secure the tool in each configuration of the plurality of configurations.

2. The multi-purpose tool of claim 1, wherein each of the outer elongated member and the intermediate elongated member comprises
a rearwall,
a first sidewall projecting from the rearwall, the first sidewall having structure defining a plurality of apertures, and
a second sidewall projecting from the rearwall, the second sidewall structure defining containing a plurality of apertures; and
wherein the inner elongated member comprises
four sidewalls, such that the third cross-sectional area defines a square, wherein at least two of the four sidewalls having structure defining a plurality of apertures; and
wherein the at least one locking mechanism comprises a clevis fastener including a pin and a clevis extending from a head of the pin and capable of locking to a tail of the pin, wherein the pin is insertable through corresponding apertures of the at least one of the outer elongated member, the intermediate elongated member, and the inner elongated member to secure the tool in each configuration of the plurality of configurations.

3. The tool of claim 1, wherein the tool presents a first tool length that is substantially equal to the first length of the outer member when the intermediate member and the inner member are completely nested.

4. The tool of claim 1, wherein at least one of the intermediate member and the inner member is collinearly extendable with respect to the outer member to define a second tool length greater than the first tool length.

5. The tool of claim 1, wherein at least one of the intermediate member and the inner member is shifted with respect to the outer member to define a non-collinear configuration.

6. The tool of claim 5, wherein the at least one locking member secures each of the inner, outer, and intermediate members to each other in a tripod configuration.

7. The tool of claim 5, wherein the at least one locking member secures at least one of the inner and intermediate member at a substantially 90-degree angle at a position along the first length of the outer member.

8. The tool of claim 2, further comprising a strap capable of operably coupling to at least one of the outer elongated member, the intermediate elongated member, and the inner elongated member.

9. The tool of claim 2, further comprising a support member including structure defining at least one aperture, and a second locking mechanism, wherein the second locking mechanism is engageable with the support member to secure the support member to at least one of the inner, intermediate, and outer members.

10. The tool of claim 9, wherein the support member is engageable with the at least one application-specific accessory to couple the tool to the at least one application-specific accessory.

11. The tool of claim 9, wherein the support member is an L-shaped joint, and wherein the support member engages the outer member at a first end of the support member, and one of the intermediate and inner members at a second end of the support member such that the one of the inner and intermediate members is positioned at a substantially 90-degree angle from the outer member.

12. The tool of claim 9, wherein the support member is a disc, and wherein the support member engages the outer member at a first angle at substantially intermediate the first length, the intermediate member at a second angle substantially intermediate the second length, and the inner member at a third angle at substantially intermediate the third length in a tripod configuration.

13. A camping tool and accessory system, the system comprising:
at least one tool having a plurality of nestable members; and
at least one application-specific accessory capable of operably coupling to at least one of the plurality of nestable members.

14. The system of claim 13, wherein the at least one tool having a plurality of nestable members comprises:
an outer elongated member presenting a first cross-sectional area and a first length;
an intermediate elongated member presenting a second cross-sectional area and a second length, wherein the second cross-sectional area is less than the first cross-sectional area such that the intermediate elongated member is nestable within the outer elongated member;
an inner elongated member presenting a third cross-sectional area and a third length, wherein the third cross-sectional area is less than the first and second cross-sectional areas such that the inner elongated member is nestable within the outer elongated member and the intermediate elongated member,
wherein the outer, inner, and intermediate members are coaxial and the inner elongated member is at least partly enclosed within the outer elongated member and the intermediate elongated member when nested, and
wherein the outer, inner, and intermediate members are shiftable relative to each other to shift the tool between a plurality of tool configurations; and
at least one locking mechanism, the at least one locking mechanism engageable with the outer member, intermediate member, and inner member to secure the tool in each configuration of the plurality of configurations.

15. The system of claim 14, wherein each of the outer elongated member and the intermediate elongated member comprises
a rearwall,
a first sidewall projecting from the rearwall, the first sidewall having structure defining a plurality of apertures, and
a second sidewall projecting from the rearwall, the second sidewall structure defining containing a plurality of apertures; and
wherein the inner elongated member comprises
four sidewalls, such that the third cross-sectional area defines a square, wherein at least two of the four sidewalls having structure defining a plurality of apertures; and
wherein the at least one locking mechanism comprises a clevis fastener including a pin and a clevis extending from a head of the pin and capable of locking to a tail of the pin, wherein the pin is insertable through corresponding apertures of the at least one of the outer elongated member, the intermediate elongated member, and the inner elongated member to secure the tool in each configuration of the plurality of configurations.

16. The system of claim 13, wherein the at least one application-specific accessory is a squared gland to form a grip or handle, the squared gland capable of operably coupling to at least one of the outer elongated member, the intermediate elongated member, and the inner elongated member.

17. The system of claim 13, wherein the at least one application-specific accessory is a head operably coupled to an end of at least one of the outer elongated member, the intermediate elongated member, and the inner elongated member, and selected from the group consisting of a pool cue head, a shovel head, a hoe head, a fishing net head, a spear head, a pitchfork head, a camera mount head, a canoe paddle head, a mirror holder head, and a window squeegee head.

18. The system of claim 13, wherein the at least one application-specific accessory is a shower bag.

19. The system of claim 13, wherein the at least one application-specific accessory is a tarp covering.

20. The system of claim 13, wherein the at least one application-specific accessory is a minnow seine netting.

21. The system of claim 13, wherein the at least one application-specific accessory is a saw blade.

22. The system of claim 13, wherein the at least one application-specific accessory is a camping chair seat comprising:
a first receivable pocket for receiving the outer member,
a second receivable pocket for receiving the intermediate member, and
a third receivable pocket for receiving the inner member.

23. The system of claim 13, wherein the at least one application-specific accessory is a grill grate.

24. A foldable grill grate comprising:
a first outer section;
a first inner section;
a second inner section; and
a second outer section;
wherein the first outer section is hingedly coupled to the first inner section, the first inner section is hingedly coupled to the second inner section, and the second inner section is hingedly coupled to the second outer section.

25. A camping supply kit comprising:
at least one multi-purpose tool capable of operably coupling to at least one application-specific accessory, the multi-purpose tool comprising:
an outer elongated member presenting a first cross-sectional area and a first length;
an intermediate elongated member presenting a second cross-sectional area and a second length, wherein the second cross-sectional area is less than the first cross-sectional area such that the intermediate elongated member is nestable within the outer elongated member;
an inner elongated member presenting a third cross-sectional area and a third length, wherein the third cross-sectional area is less than the first and second cross-sectional areas such that the inner elongated member is nestable within the outer elongated member and the intermediate elongated member,
wherein the outer, inner, and intermediate members are coaxial and the inner elongated member is at least partly enclosed within the outer elongated member and the intermediate elongated member when nested, and
wherein the outer, inner, and intermediate members are shiftable relative to each other to shift the tool between a plurality of tool configurations; and
at least one locking mechanism, the at least one locking mechanism engageable with the outer member, intermediate member, and inner member to secure the tool in each configuration of the plurality of configurations.
at least one fire-starting device;
at least one container containing salt;
at least one container containing pepper;
at least one scotch pad;
at least one hot dog roaster; and
at least one grill grate;

26. The camping supply kit according to claim 25, wherein the at least one fire-starting device is selected from the group consisting of a book of matches and a lighter.
